(19) United States
(12) Patent Application Publication
(10) Pub. No.: US 2016/0220000 A1
(43) Pub. Date: Aug. 4, 2016

(54) CASE FOR AN ELECTRONIC DEVICE

(71) Applicant: Bradley MCGUCKIN, Surrey (GB)

(72) Inventor: Bradley McGuckin, Surrey (GB)

(21) Appl. No.: 14/916,718

(22) PCT Filed: Sep. 16, 2014
(86) PCT No.: PCT/GB2014/000371

§ 371 Date: Mar. 4, 2016

(30) Foreign Application Priority Data
Sep. 16, 2013 (GB) 1316441.3

(51) Int. Cl. A45C 11/00; B65H 75/44; H04R 1/10; B65H 75/14; A45F 5/00; H02G 11/02

(52) U.S. Cl. CPC A45C 11/00; A45F 5/00; H02G 11/02; H04R 1/1033; B65H 75/143; B65H 75/4473; A45C 2011/002; A45C 2011/001; B65H 2701/3919; B65H 2701/536

(57) ABSTRACT

A case for an electronic device, which case comprises a housing (1) arranged to engage at least two sides of an electronic device. The housing (1) has an outer surface for receiving a resilient cover (2). The resilient cover (2) is movable from a closed position to an open position. In the closed position, the resilient cover (2) is adapted to define, in part, a volume formed between the outer surface and the resilient cover (2). The case further comprises a cylindrical protrusion (4) which projects from the outer surface. The resilient cover (2) has two parts: a resilient part (2) which is arranged around a reinforcing element (3). In use, a cable is insertable into the volume by moving the resilient cover (2) into the open position to allow a cable to be wound about the cylindrical protrusion (4) and then retained by the resilient cover (2) when the resilient cover (2) returns to the closed position.

### CROSS-REFERENCE TO RELATED APPLICATIONS

This application claims priority to GB Patent Application No. 1316441.3 filed on Sep. 16, 2013.

### BACKGROUND OF THE INVENTION

1. Field of the Invention

The present invention relates to a case for an electronic device, in particular, but not exclusively, the present invention relates to a case for a phone or media player arranged to allow a cable to be retained by a resilient cover.

Electronic devices capable of reproducing sounds such as music are very popular with the public for several reasons. In particular, because they allow users to choose their acoustic environment. Typically, sound reproducing electronic devices are used in conjunction with headphones to prevent users from disturbing or distracting others. However, one of the problems of using headphones is that the headphone cable easily becomes tangled.

The present invention therefore aims to provide an electronic device case capable of providing a neat and compact storage solution for headphones.

2. Description of Related Art

WO2012/125690 discloses a media player or phone case comprising an opening for receiving a panel comprising two socket cavities, each cavity having a male snap fit element. The phone case also comprises two buttons, each button comprising a flexible concertinaed portion and a lower female snap fit element arranged to connect a respective button to the relevant male snap fit element on the panel. The case further comprises port, camera, audio and other appropriate openings to allow the media player or phone to function normally. In use, a headphone cord is wound around the two flexible concertinaed portions and these are then partially retracted.

US2009/0036175 describes a mobile phone case consisting of two parts, a shell and an insert which are assembled into a case with a back outer reel arranged to function as a spool for a headphone cable. A couple of projections on the sides of the exterior surface can be used to secure the top portion of the cable.

US2009/0101782 discloses a clamping device arranged to be attached to an electronic product. The device comprises an off centre element arranged to clamp the device onto an electronic apparatus by either suction or adhesion (not specified). The device further comprises a flexible cross-shaped element with a flexible steel sheet edge. Four non-slip projections are provided, one on each arm of the cross-shaped element. In use, the cross-shaped element may create a dome by directing the four arms towards the electric apparatus so as to allow a belt to be passed between the device and the electronic apparatus. Alternatively, the arms of the cross-shaped element may be directed away from apparatus so that the lower arms can be used as a resting foot. In this latter configuration, the headphone cord may be wound around the off centre element.

US2011/0095119 discloses a cable coiling apparatus comprising a main body which has a base, a top cap which is substantially parallel to the base and a central post which extends from the top surface of the base to the top cap. The top cap comprises a channel around its perimeter; the channel is arranged to secure a resilient cover which resilient cover is movable from a closed position and an open position. In the closed position, the resilient cover resembles a dome and therefore the inner surface of the cover has a substantially concave shape in relation to the base whereas in the open position, the resilient cover has a substantially convex shape in relation to the base. Additional channels are provided on the top surface of the base. In use, a cable may be wound around the central post when the resilient cover is in the open position while cable ends may be accommodated in the channels on the top surface of the base.

US2013/0083456 discloses a mobile device case having a reel assembly. The reel assembly comprises a reel, a supporting plate, and a hub between the reel and the supporting plate. The hub includes a first cavity arranged to house a spring, and a second cavity arranged to house a flat flexible cable. The spring is wound in a first direction, while the flat flexible cable is wound in the opposite direction. In use, when the reel rotates in the first direction, the spring tightens and the flat flexible cable loosens. In contrast, when the reel rotates in the opposite direction, the spring loosens and the flexible cable tightens.

The cases and clamping devices described above are overly complicated and comprise a substantial number of parts. Moreover, some of the devices mentioned above are not suitable to be carried inside a bag or pocket as the cable wound on the device spool is exposed and could therefore be caught on other items being carried in the same bag or pocket. Further, the cable coiling apparatus described in US2011/0095119 is unsuitable for use on a portable media case.

### SUMMARY OF THE INVENTION

According to the present invention there is provided a case for an electronic device the case comprising: a housing having an outer surface; a resilient cover movable from a closed position to an open position and arranged, in the closed position, to define in part a volume formed between the outer surface and the resilient cover; and cable engaging means about which a cable can be wound, which cable engaging means projects from the outer surface; wherein a cable is insertable into the volume by moving the resilient cover into the open position to allow a cable to be wound about the cable engaging means and retained by the resilient cover, when the resilient cover is in the closed position, wherein the resilient cover has two parts, a resilient part arranged around a reinforcing element, which reinforcing element is made from a substantially rigid material.

This case is advantageous because it allows a cable for a set of headphones to be stored neatly and securely in the case when not in use. Accordingly, it increases the usable life of the headphone cable and allows it to be kept untangled. Further, the case is also advantageous because it is compact and therefore easy to carry as one unit. Moreover, because the resilient cover has two parts it increases the structural integrity of the resilient cover and therefore enables it to be kept in the closed position even when the case is subjected to accidental movements or subjected to pressure from coiled or bunched cables underneath. This feature also facilitates keeping the resilient cover height to a minimum vertical height. When winding cables onto a spool these cables have a natural tendency to stack vertically and force or retard the known resilient covers upwards. The resilient cover of the present invention has the advantage of forcing the cable being stored to stack laterally in a substantially flat spiral thereby enabling the cover height to be kept as low as possible. This feature further contributes to allowing the case to be compact.

In a preferred embodiment, the outer surface is provided with a recess having an edge and a lip around the edge, which lip is arranged to secure an edge of the resilient cover. This feature has the advantage of preventing the resilient cover from moving from the closed position to the open position when the resilient cover is subjected to accidental forces.

Advantageously, the resilient part has an opening and a substantially flat recess; and the reinforcing element has a projection arranged to pass through the opening and to engage the cable engaging means; so that the reinforcing element is substantially flush with the overall profile of the resilient cover when received by the flat recess. This feature allows the resilient cover to be reliably secured to the housing.

More advantageously, the resilient part comprises a cut-out and a lip provided around the cut-out, and the reinforcing element has a top planar surface having a raised edge and a channel for engaging the lip is provided around the edge, wherein the lip and the channel are coupled in an interference fit arrangement. This feature allows the resilient cover to store the energy generated by the interference fit so that it can be used to easily upturn the resilient cover and then return it to the closed position.

In a preferred embodiment, the cable engaging means has a cut-out arranged to receive a volume control on a cable. This feature is advantageous because it prevents a control volume from forcing the resilient cover open by moving around inside it.

In a further preferred embodiment, the outer surface has at least one earpiece receiving recess therein. This is advantageous because it allows the earpieces to be secured to the housing in a neat manner.

In another preferred embodiment, the recess has an increased wall thickness. This feature increases the structural integrity of the resilient cover and case.

Preferably, the outer surface comprises a pair of guiding grooves arranged to receive a pair of earpiece stems. More preferably, the guiding grooves are provided in an area of the housing having an increased cross-section. These features allow the earpieces to be held securely by the case.

In a further preferred embodiment, the housing has an indent arranged to allow a user to move the resilient cover from the closed position to the open position. This feature facilitates use of the case by allowing a user to move the resilient cover from the closed into the open position quickly.

In another preferred embodiment, the housing has at least one opening arranged to allow a button and/or a port and/or a camera and/or a camera flash and/or a speaker to remain unobstructed by the housing. This feature allows the case to be used permanently or semi-permanently with the electronic device, i.e. it does not need to be removed for everyday uses of the device which do not require headphones.

### BRIEF DESCRIPTION OF THE DRAWINGS

A preferred embodiment of the present invention will now be described, by way of example, with reference to the accompanying drawings, in which:

FIG. 1 is an exploded view of phone case according to a first embodiment of the present invention;

FIG. 2 is a is a perspective view of the phone case of FIG. 1;

FIG. 3 is a top view of the phone case of FIG. 1;

FIG. 4 is a perspective view of the phone case when the resilient cover is in the open position;

FIG. 5 is a cutaway view of the phone case being used to wind headphones;

FIG. 6 is a perspective view of the phone case of FIG. 1 whilst in use;

FIG. 7 is an exploded view of a phone case according to a second embodiment of the present invention;

FIG. 8 is a side view of the resilient cover and the reinforcing element of FIG. 7;

FIG. 9 is a top view of the resilient cover and the reinforcing element of FIG. 7;

FIG. 10 is a cut-away view of an assembled phone case according to the second embodiment of the present invention;

FIG. 11 is a detailed view of the connection of the resilient cover and the reinforcing element as shown in FIG. 10; and

FIG. 12 is a perspective view of the assembled phone case according to the second embodiment of the present invention.

### DETAILED DESCRIPTION OF PREFERRED EMBODIMENTS

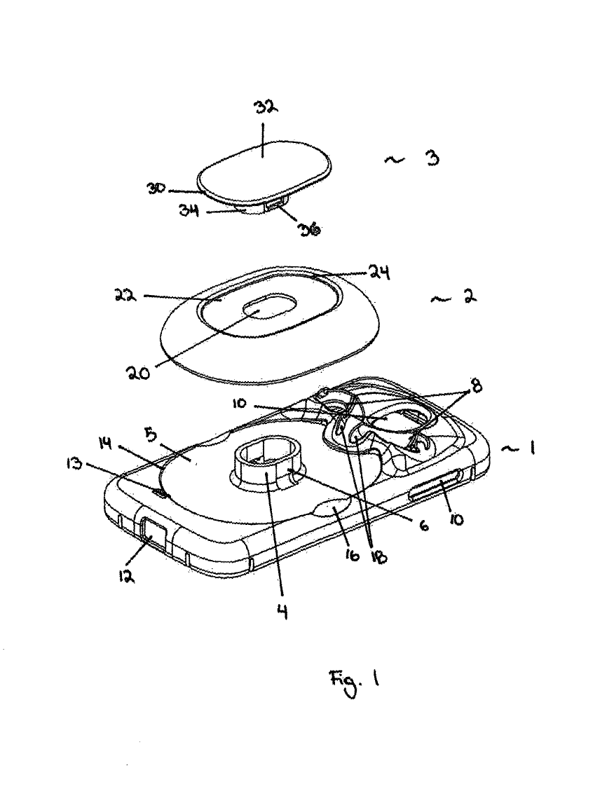

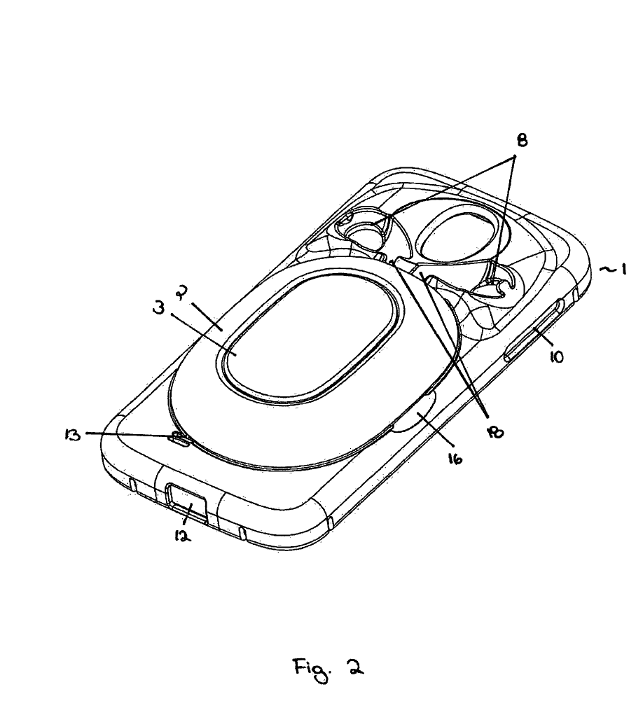

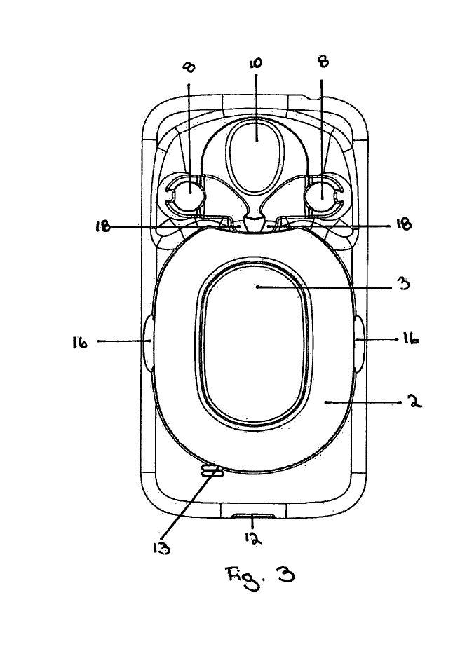

In the drawings, like parts are denoted by like reference numerals. Referring now to FIGS. 1, 2 and 3, there is shown a phone case having a substantially rectangular housing 1 arranged to receive a mobile phone. The housing is made from plastic material and comprises a generally planar inner wall arranged to abut the back wall of a mobile phone and four side walls arranged to engage the mobile phone so as to retain it in the housing 1. When a mobile phone is retained in the housing 1, an outer surface, i.e. the back face of the inner wall, is visible while the back wall of the mobile phone remains in the housing. The outer surface is provided with a recess 5 arranged to receive a resilient cover 2 having a reinforcing element 3. A lip 14 is provided around the periphery of the recess 5 so as to engage the edge of the resilient cover 2. In addition, at least one indentation 16 arranged to allow a user to insert a finger under the resilient cover 2 and lift it is provided on the periphery of the recess 5 and the outer surface of the housing 1. In addition, a small opening 13 for keeping a speaker provided on a phone unobstructed.

In this particular embodiment, the area of the recess 5 has an increased wall thickness which adds rigidity to the housing 1. A cable engaging means about which a cable can be wound, which, in this embodiment is a cylindrical protrusion 4, is located axially on the recess 5. The cylindrical protrusion 4 is arranged to support the resilient cover 2. The cylindrical protrusion 4 is further arranged to form a winding surface or spool for a headphone cable connected to the mobile phone. At least one headphone receiving recess 8 arranged to receive earpieces is provided on the reverse face of the planar wall remote from the resilient cover 2; the earpiece receiving recess or recesses is or are profiled and surrounded by a raised area having a pair of guiding grooves 18, each guiding groove 18 configured to retain the stem of an earpiece. In this specific embodiment, the guiding grooves are provided in an area of the outer surface of the housing which has an increased cross-section, i.e. an area which is raised in relation to the rest of the outer surface. The housing further comprises at least one opening 10 so that any button and/or a camera on the mobile phone remains unobstructed and operational. An additional opening 12 is provided on a side wall to allow a charging port to remain unobstructed.

The resilient cover 2 is substantially dome-shaped and has a generally central opening 20 arranged to allow the resilient cover 2 to engage the cylindrical protrusion 4. A substantially flat recess 22 arranged to receive the reinforcing element 3 is provided on the outer surface of the dome so as to create a flush surface when the reinforcing element is fixed. The periphery of the flat recess 22 has a lip or rim 24 arranged to engage with the rim 30 of the reinforcing element 3.

The reinforcing element 3 is a generally T-shaped structure having a top planar surface 32 and a projection 34 arranged to go through the central opening 20 and engage the cylindrical protrusion 4 so as to connect the resilient cover 2 with the reinforcing element 3 to the housing. A detent 36 is provided on the projection 34 to secure the resilient cover 2 with a reinforcing element 3 to the housing. The cut-out 6 arranged to receive the detent 36 provided on either side of the cylindrical protrusion 4 so that when the reinforcing element 3 engages the cylindrical protrusion 4, the detent 36 is secured in a latch arrangement. The combination of the resilient cover 2 and the reinforcing element 3 force the cable being stored in the case to stack laterally, that is, in a flat spiral. Preferably, the spiral lies in a single plane.

The housing 1 and reinforcing element 3 may be made from plastics materials such as polyurethane, polycarbonate, polyethylene, or any other suitable plastic material. The resilient cover 2 is made from a resilient material, preferably plastic or rubber. In this particular embodiment, the cylindrical protrusion 4 is made from the same plastic material as the housing 1 and is also made in the same mould as the housing; thus, the cylindrical protrusion 4 is integral with the housing 1.

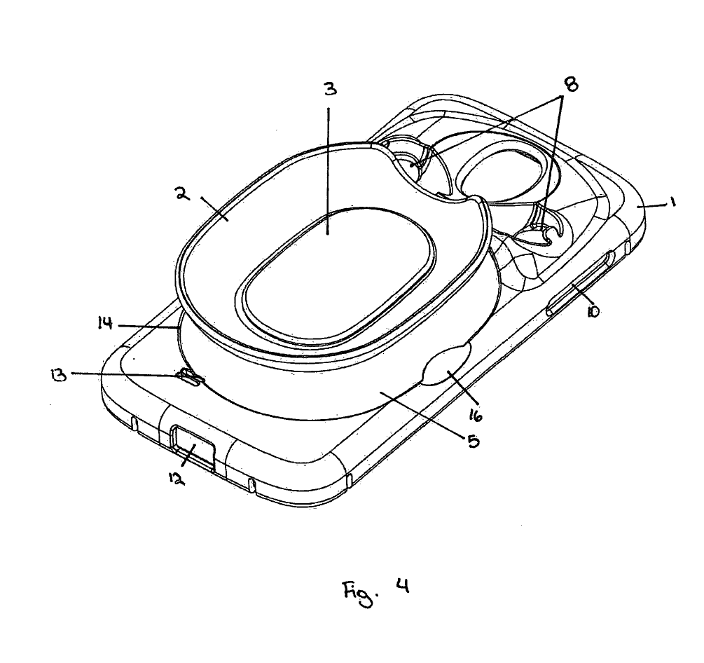

Referring now to FIG. 4, the resilient cover 2 is moveable from a closed position to an open position. In the closed position, the resilient cover 2 is substantially dome-shaped and its edge is engaged with the lip 14, i.e. the resilient cover 2 abuts the recess 5; whereas, in the open position, the rounded portion of the resilient cover 2 is reversed so that the resilient cover 2 resembles a reversed dome or an upturned umbrella with a generally flat base provided by combination of the flat recess 22 and the top planar surface 32. In the open position, the space between reverse face of the flat recess 22 and the recess 5 is accessible. In order to upturn or lift the resilient cover 2, a user introduces a finger through the indentation 16 and applies an upward force on the resilient cover 2. When the resilient cover 2 is upturned, the recess 5, the cylindrical protrusion and the cut-out are accessible so that a user can use the cylindrical protrusion 4 as a spool to wind a headphone cable around it. As shown in this Figure, the reinforcing element 3 remains statically connected to the housing, securing the resilient cover 2 thereto.

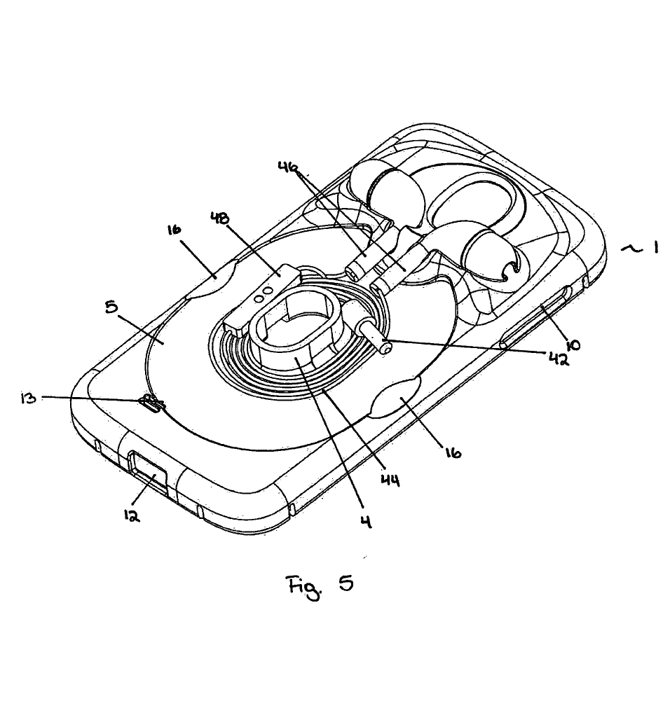

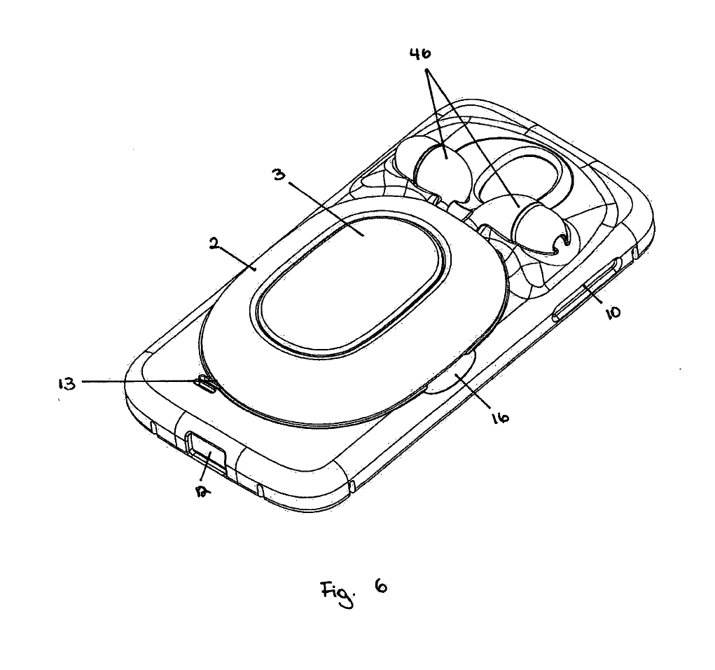

Referring now to FIGS. 5 and 6 there is shown a phone case according to a preferred embodiment of the present invention when in use. As seen in FIG. 5, a set of headphones 40 having a plug 42, a cable 44, a pair of earpieces 46 and a volume control 48 can be stored in the space between the recess 5 and the reverse face of the flat recess 22. The stem of each earpiece 46 is engaged by the respective guiding groove 18 and the ear insertable part is inserted into the respective profiled earpiece receiving recess 8. The cable 44 is then wound around the cylindrical protrusion 4. When a user has finished winding the cable around the cylindrical protrusion 4 and has placed the plug 42 in the space between the recess 5 and the reverse face of the resilient cover 2, the resilient cover 2 can be moved back into its closed position in which the lip 14 secures the resilient cover 2.

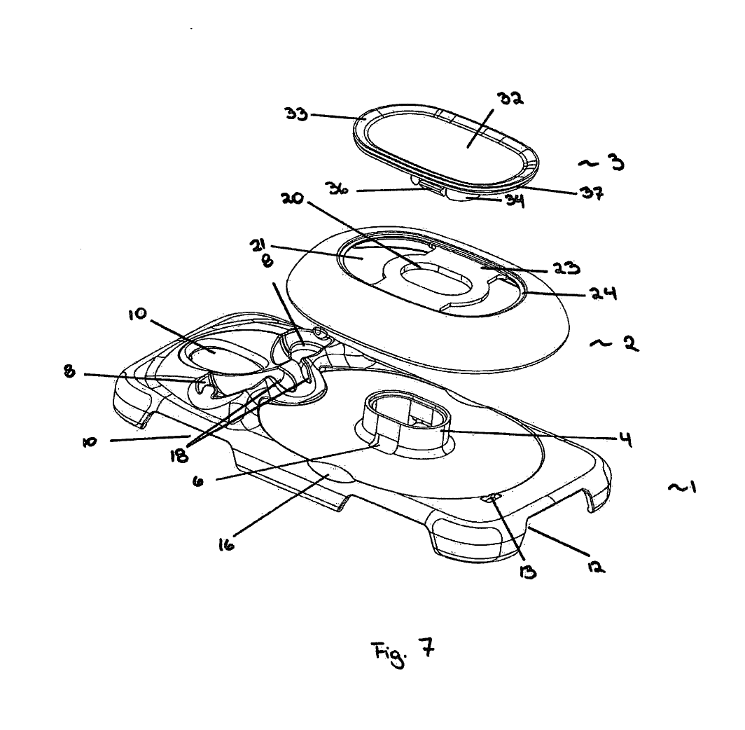

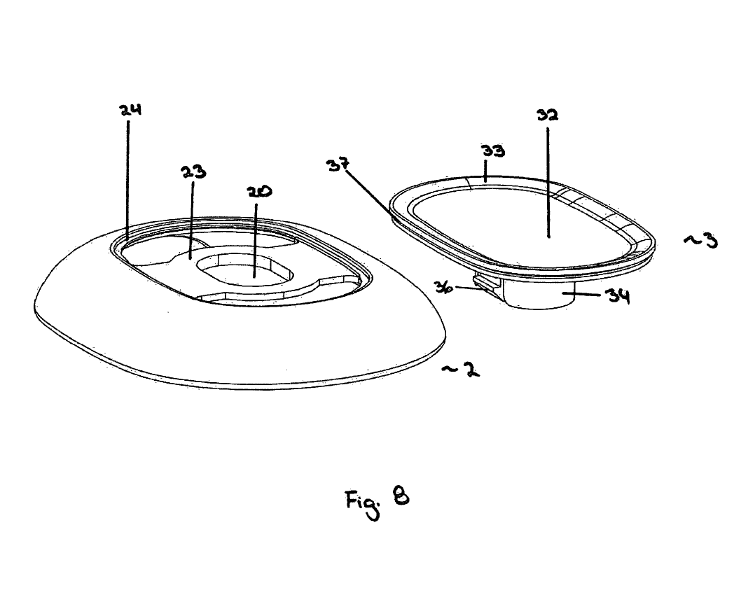

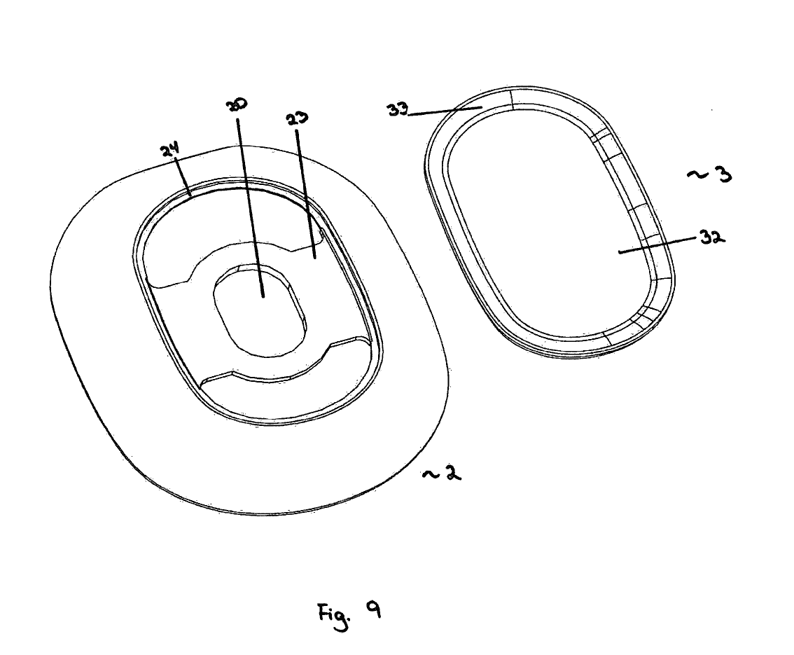

Referring now to FIGS. 7, 8 and 9 there is shown a phone case according to a second embodiment of the present invention. The phone case of this second embodiment is very similar to that of the first embodiment in that it comprises a substantially rectangular housing 1 made from plastic material, the housing comprising a substantially planar wall and four partial side walls. In this embodiment, openings 10 and 12 are created by the partial side walls. A recess 5 for receiving a resilient cover 2 is arranged on the outer surface. At least one indentation 16 arranged to facilitate lifting of the resilient cover 2 is provided on the periphery of the recess 5 and the outer surface of the housing 1. A lip 14 arranged to engage the edge of the resilient cover 2 is provided around the periphery of the recess 5. Cable engaging means about which a cable can be wound is provided in the form of a cylindrical protrusion 4 located axially on the recess 5. As in the previous embodiment, the cylindrical protrusion 4 is adapted to support the resilient cover and comprises a cut-out 6 arranged to engage a detent 36. Profiled headphone receiving recesses 8 are provided on a raised area on the outer surface remote form the resilient cover 2. Guiding grooves 18 arranged to retain the stem of an earpiece or the earpiece itself are located in the raised area. In this embodiment, a small opening 13 is provided to keep a speaker provided on a phone unobstructed.

In this embodiment, the resilient cover 2 is substantially dome-shaped and has a central cut-out 21 and a substantially flat projection 23 which joins two sides of the resilient cover 2. A lip 24 is provided around the central cut-out 23. The flat projection is provided with a generally central opening 20 for allowing the resilient cover 2 to engage the cylindrical protrusion 4.

A generally T-shaped reinforcing element 3 is provided on the resilient cover. The reinforcing element has a top planar surface 32 having a raised edge 33, i.e. the edge has an increased cross-section. A channel 37 for engaging the lip 24 under tension is provided around the edge 33. The reinforcing element further comprises a projection 34 arranged to traverse the central opening 20 and engage the cylindrical protrusion 4 by means of a detent 36 which engages the cut-out 6 on the cylindrical protrusion 4, this enables the resilient cover 2 to be coupled to the housing 1.

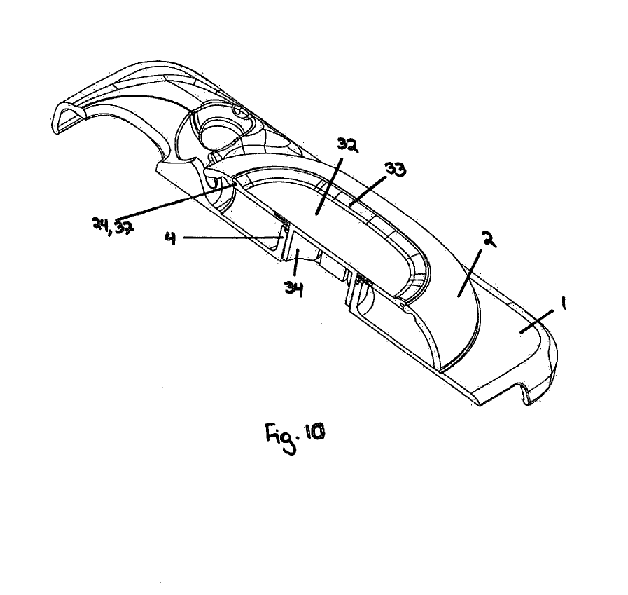

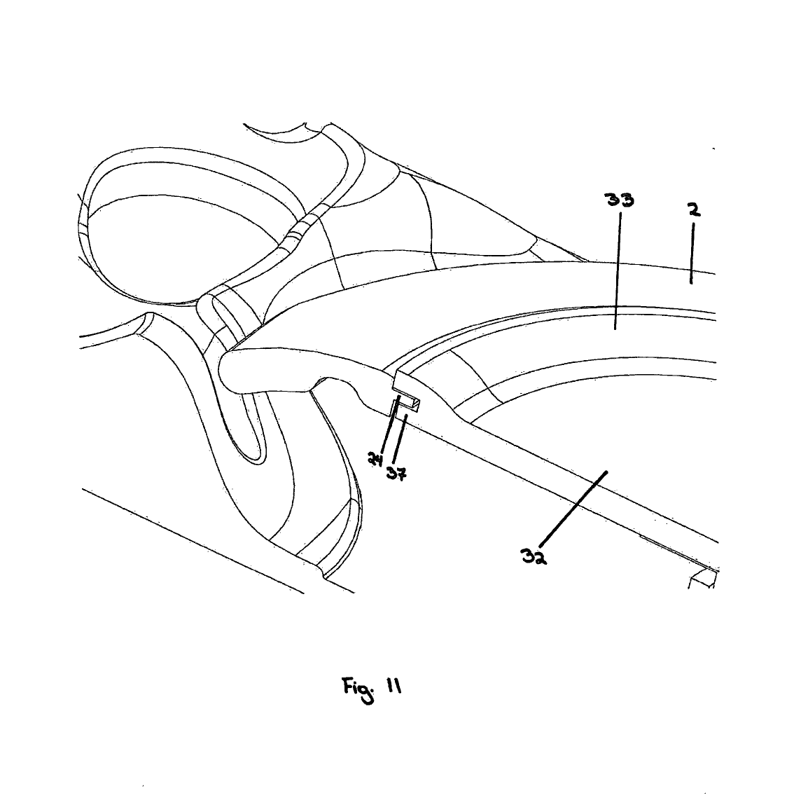

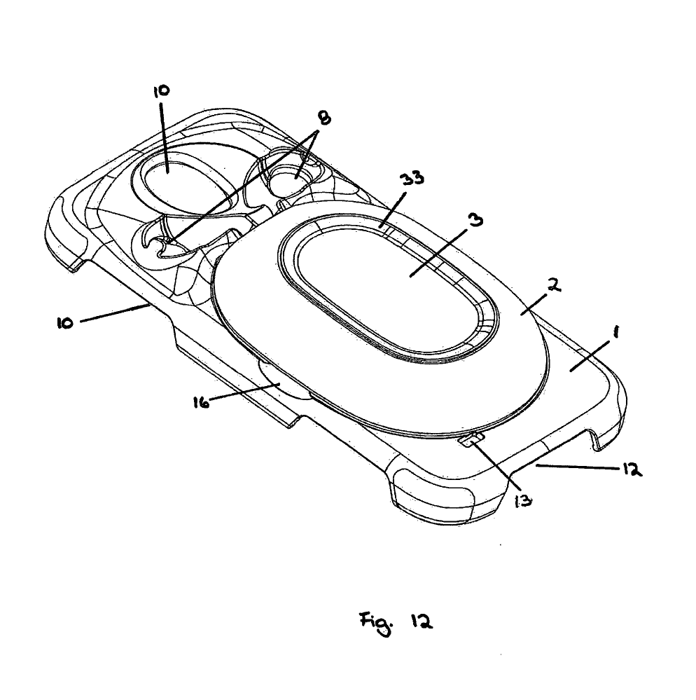

Referring now to FIGS. 10, 11 and 12, the resilient cover 2 and lip 24 of this embodiment are relatively flexible to engage with the channel 37. The resilient cover and lip may be made from plastic materials, rubber or silicone, for example. The reinforcing element 3 is made from a material harder than that of the resilient cover 2, for example: polyurethane, polycarbonate, polyethylene, or any other suitable plastic material. In this embodiment, the top planar surface 32 has a marginally larger dimension than the cut-out 21 and therefore, in use, both parts are held together in an interference fit arrangement. The interference fit provides the resilient cover 2 with sufficient tension to be resiliently biased to the closed position from where it can be lifted and, in an over-centre movement, be resiliently biased to the open position; subsequently, the resilient cover 2 is returnable to its original closed configuration. Further, as the reinforcing element 3 is made from a material which is harder than that of the resilient cover 2, the tension is stored by the resilient cover 2. The top surface 32 of the reinforcing element 3 is somewhat concave relative to the resilient cover 2 and the edge 33 to provide clearance for overturning the resilient cover 2. As seen specifically in FIG. 11, the resilient cover 2 of this embodiment is asymmetrical so that it can accommodate the raised area on the outer surface of the housing 1. The combination of the resilient cover 2 and the reinforcing element 3 held together in an interference fit arrangement force the cable being stored in the case to stack laterally.

In an alternative embodiment (not shown), the reinforcing element could be replaced by an increased wall section on the central part of the resilient cover, a harder grade material being used for the central part of the resilient cover or both of the aforementioned options. In a further alternative embodiment, the reinforcing element could be welded or adhered to the cylindrical protrusion instead of being secured by a detent or an interference fit.

In another alternative embodiment (not shown), the cylindrical protrusion is provided on a rotating disc on the recess to allow a single cut-out to be used on either side of the housing and to allow the cylindrical protrusion to be rotatable. A corresponding rotating disc is provided on the reverse face of the planar surface to allow the projection to be synchronously rotatable with the cylindrical protrusion. Equally, the projection could be a bore or any other means which allow the cylindrical protrusion to rotate around it.

In a further embodiment (not shown) a cut-out for receiving a volume control could be provided on at least one side of the cylindrical protrusion to allow the volume control to be secured when a cable is wound around the cylindrical protrusion.

Although the housing described above has four walls arranged to engage a mobile phone, it should be clear that any other means which enable the housing to engage a mobile phone such as hooks could be used. Further, it should also be clear that the number of side walls or device engaging means could be two or three instead of four.

Further, it should also be apparent that the recess, the reinforcing element arranged centrally on the resilient cover and the central opening need not be arranged centrally and could be arranged in an offset or asymmetrical position. Moreover, it should also be clear that a recess need not be provided on the outer surface of the housing; if a recess is not provided, the resilient cover would simply abut the outer surface of the housing.

While the embodiments described above in relation to the drawings comprise at least one indentation arranged to facilitate lifting of the resilient cover and, in addition, guiding grooves arranged to retain the stem of an earpiece or the earpiece itself, these features are not essential and could be omitted.

It should be noted that although the embodiments described above refer to an unplugged set of headphones, it would possible to wind the cable around the cylindrical protrusion and insert the earpieces into the earpiece receiving recesses whilst the plug is connected to a mobile phone by passing the cable through an opening formed by corresponding opposing notches on the resilient cover and the outer surface.

Although the present invention has been described as a mobile phone case, it should be apparent that the case may also be used with any other electronic device which requires headphones such as a tablet computer, an e-reader, a music player, or a PDA.

1. A case for an electronic device the case comprising:
a housing (1) having an outer surface;
a resilient cover (2) movable from a closed position to an open position and arranged, in the closed position, to define in part a volume formed between the outer surface and the resilient cover (2); and
a cable engaging means about which a cable can be wound, which cable engaging means projects from the outer surface;
wherein a cable is insertable into the volume by moving the resilient cover (2) into the open position to allow a cable to be wound about the cable engaging means and retained by the resilient cover (2), when the resilient cover (2) is in the closed position, and
wherein the resilient cover (2) has two parts, a resilient part (2) arranged around a reinforcing element (3), which reinforcing element (3) is made from a substantially rigid material.

2. The case for an electronic device according to claim 1, wherein the outer surface is provided with a recess (5) having an edge and a lip (14) around the edge, which lip (14) is arranged to secure an edge of the resilient cover (2).

3. The case for an electronic device according to claim 1, wherein the resilient part (2) has an opening (20) and a substantially flat recess (22); and the reinforcing element (3) has a projection (34) arranged to pass through the opening (20) and to engage the cable engaging means; so that the reinforcing element (3) is substantially flush with an overall profile of the resilient cover (2) when received by the flat recess (22).

4. The case for an electronic device according to claim 1, wherein the resilient part (2) comprises a cut-out (23) and a lip (24) provided around the cut-out (24), and the reinforcing element (3) has a top planar surface (32) having a raised edge (33) and a channel (37) for engaging the lip (24) is provided around the raised edge (33), wherein the lip (24) and the channel (37) are coupled in an interference fit arrangement.

5. The case for an electronic device according to claim 1, wherein the cable engaging means has a cut-out arranged to receive a volume control (48) on a cable.

6. The case for an electronic device according to claim 1, wherein the outer surface has at least one earpiece receiving recess (8) therein.

7. The case for an electronic device according to claim 2, wherein the recess (5) has an increased wall thickness.

8. The case for an electronic device according to claim 1, wherein the outer surface comprises a pair of guiding grooves (18) arranged to receive a pair of earpiece stems (46).

9. The case for an electronic device according to claim 8, wherein the guiding grooves (18) are provided in an area of the housing (1) having an increased cross-section.

10. The case for an electronic device according to claim 1, wherein the housing (1) has an indent (16) arranged to allow a user to move the resilient cover (2) from the closed position to the open position.

11. The case for an electronic device according to claim 1, wherein the housing (1) has at least one opening (10, 12, 13) arranged to allow a button and/or a port and/or a camera and/or a camera flash and/or a speaker to remain unobstructed by the housing (1).
